(19) United States
(12) Patent Application Publication
(10) Pub. No.: US 2010/0150486 A1
(43) Pub. Date: Jun. 17, 2010

(54) ASSEMBLIES AND METHODS FOR MULTISTAGE SEALING OF ROLLER BEARINGS

(75) Inventors: Sudhakar Kuppuraju, North Canton, OH (US); Gerald P. Fox, Massillon, OH (US); Richard Borowski, Canton, OH (US); Thierry Pontius, Hunawihr (FR); Paul Shiller, Youngstown, OH (US)

Correspondence Address: Polster, Lieder, Woodruff & Lucchesi, L.C., 12412 Powerscourt Dr. Suite 200, St. Louis, MO, 63131-3615, US

(73) Assignee: THE TIMKEN COMPANY, Canton, OH (US)

(21) Appl. No.: 12/298,498

(22) PCT Filed: Apr. 26, 2007
(86) PCT No.: PCT/US07/67513

§ 371 Date: Jun. 24, 2009

Related U.S. Application Data
(60) Provisional application No. 60/795,002, filed on Apr. 26, 2006.
(60) Provisional application No. 60/883,451, filed on Jan. 4, 2007.

(51) Int. Cl. F16C 33/76

(52) U.S. Cl. 384/486

(57) ABSTRACT

A bearing assembly for accommodating rotation about an axis includes an outer race (2) having a raceway (6) presented toward the axis and an inner race (4) having a raceway (8) presented toward the raceway (6) of the outer race (2) and forming a bore (12) there between. The inner race (4) includes at an end a sealing surface (20) that is inclined away from the raceways (6, 8) and toward the axis. Rollers (16) are arranged in a row between the outer raceway (6) and the inner raceway (8). A seal (22) closes the end of the bore (12). The seal (22) includes a seal case (24) supported by the outer race (2) at its end. A first sealing element (26) is carried by the seal case (24) and bears against the sealing surface (20) on the inner race (4) and forms a first stage sealing contact. A second sealing element (36) is carried by the seal case (24) and forms second stage sealing contact.

### CROSS REFERENCE TO RELATED APPLICATIONS

This application claims the benefit of U.S. Provisional Application No. 60/795,002, entitled SPHERICAL ROLLER BEARING WITH MULTISTAGE SEALS, filed on Apr. 26, 2006; and U.S. Provisional Application No. 60/883,451, entitled SPHERICAL ROLLER BEARING WITH MULTISTAGE SEALS, filed on Jan. 4, 2007. The disclosures of the above applications are incorporated herein by reference.

### FIELD

The present disclosure relates to roller bearings and, more particularly, to assemblies and methods for sealing roller bearings.

### BACKGROUND

The statements in this section merely provide background information related to the present disclosure and may not constitute prior art.

A spherical roller bearing has the capacity to accommodate misalignment, for example, between a pillow block and a shaft that rotates in the pillow block. Like other bearings, a spherical roller bearing has outer and inner races provided with opposed raceways, and also rollers located between the races. The raceway of the outer race lies within a spherical envelope having its center along the axis of that race, whereas the rollers, which are typically organized in two rows, have profiles that conform to the curvature of the outer raceway. This allows the rollers to move in an arc generally axially along the outer raceway, as a consequence of the axis of the inner race tilting or deviating from the axis of the outer race, which represents misalignment.

However, the capacity to accommodate misalignment also renders spherical roller bearings difficult to lubricate and seal. Some rely on oil that is essentially flushed through them. Generally speaking, grease provides better lubrication for such bearings, but it is difficult to retain and isolate from exterior contaminants in the presence of ever-changing alignment between the shaft and pillow block and of course between the outer and inner races along which seals normally operate.

### SUMMARY

The inventors hereof have succeeded at designing end seals for roller bearings, including spherical roller bearings.

In one aspect, a bearing assembly for accommodating rotation about an axis includes an outer race having a raceway presented toward the axis and an inner race having a raceway presented toward the raceway of the outer race. The inner race includes at an end a sealing surface that is inclined away from the raceways and toward the axis and forming a bore. Rollers are arranged in a row between the outer and inner raceways. A seal closes the end of the bore. The seal includes a seal case supported by the outer race at its end. A first sealing element is carried by the seal case, bears against the sealing surface on the inner race, and forms a first sealing contact. A second sealing element is carried by the seal case and forms a second sealing contact.

In still another aspect, a bearing assembly for accommodating rotation about an axis wherein the assembly has an outer race having an end and a raceway presented inwardly toward the axis, an inner race having an end and a raceway presented outwardly toward the raceway of the outer race for forming a bore there between, the inner race at its end includes a sealing surface that is inclined inwardly away from the raceway and toward the axis, and rollers arranged in a row between the outer and inner raceways. The bearing assembly also includes means for establishing a static fluid barrier with the outer race, means for establishing a dynamic fluid barriers with the sealing surface of the inner race, and means for establishing a second dynamic fluid barrier with at least one of the sealing surface of the inner race and a sealing surface of a shield supported by the inner race.

The present disclosure includes various aspects that will be apparent to those skilled in the art. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a cross sectional view of a bearing assembly having multistage seals according to one exemplary embodiment.

FIG. 2 is a cross sectional view of a seal suitable for implementation in some embodiments of a bearing assembly.

FIG. 3A is a cross sectional view of an inner race suitable for some embodiments of a bearing assembly.

FIG. 3B is a cross sectional view of a sealing surface of an inner race according to one embodiment of a bearing assembly.

FIG. 3C is a side view of a seal loading slot according to some embodiments.

FIG. 4A is a cross sectional view of an inner race according a second embodiment of a bearing assembly.

FIG. 4B is a cross sectional view of a sealing surface of an inner race according to another embodiment of a bearing assembly.

FIG. 5 is a cross sectional view of a bearing assembly having multistage seal according to another exemplary embodiment.

FIG. 6A is a cross sectional view of an unassembled bearing assembly having multistage seals according to some exemplary embodiments.

FIG. 6B is a cross sectional view of an assembled bearing assembly of FIG. 6A.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In one embodiment, a bearing assembly includes an outer race having one or more raceways presented inwardly toward the axis and an inner race having one or more raceways presented outwardly toward the raceways of the outer race. These raceways can be linear for receiving cylindrical rollers or can be contoured for receiving contoured rollers such as spherical rollers. The inner race can include at one or both ends a sealing surface that is inclined inwardly away from the raceways and toward the axis. These sealing surfaces can be linear or can be contoured, such as having a convex curved surface presented outwardly towards the outer race and into the bore. In some embodiments, the inner race include ribs presented outwardly toward the raceways of the outer race for securing, at least in part, a roller within the bore adjacent to an inner raceway and its corresponding outer raceway. A bore having two ends is defined between the race and the inner race. Rollers are arranged in rows between the outer and inner raceways.

A seal closes one or both ends of the bearing assembly. The seal includes a seal case supported by the outer race at its end. The seal case can be configured to compressively fit into an end of the bore against the outer race. The seal case can be supported by the outer race to establish a static fluid barrier with the outer race.

The seal also includes a first sealing element is carried by the seal case, bears against the sealing surface on the inner race, and forms a first stage sealing contact. The first sealing element can bear against the sealing surface of the inner race at a distance from the end of the bore. The first sealing element can include one or more seal lips defining one or more seal faces. Each seal lip can protrude away from the seal case and bias the seal face outwardly and against the sealing surface of the inner race. This biasing can be from the first sealing element itself or can be provided, at least in part, by a biasing element such as a finger spring, by way of example, that biases as least the seal lip or seal face in the direction of the sealing surface of the inner race. The seal lip and seal face can have any shape, and in one embodiment, the sealing lip includes a distal end having a V-shaped cross-section.

A second sealing element is also carried by the seal case and forms a second stage sealing contact. The second sealing element can also bear against the sealing surface of the inner race but proximate to the end, in some embodiments. In other embodiments, the second sealing element can form the second stage sealing contact by bearing against another surface associated with the inner race. For example, in some embodiments, a shield can be supported by the inner race, cover at least a portion of the bore, and define an inner sealing surface. In such embodiments, the second sealing element can be configured to bear against the inner surface of the shield and establish face seal contact as the second stage seal contact. This embodiment will addressed in more detail below.

The first and second sealing elements are configured to establish dynamic fluid barriers with the inner race including during rotation of the outer race about the axis and relative to the inner race. It should also be understood that additional sealing elements are also included within the scope of this disclosure, as additional first sealing elements, and/or second sealing elements, for forming additional dynamic fluid barriers. Typically, the sealing elements are deformable and resilient for providing a biasing force to provide a dynamic fluid barrier against a sealing surface.

In some embodiments, the seal includes a monolithic seal body that defines both the first sealing element and the second sealing element. The monolithic body can be composed of a single composition, or may be composed of multiple compositions, such as produced by multi-phase injection molding processes, for example. In other embodiments, the second sealing element has a body that is independent of a body of the first sealing element, e.g., each first and second sealing element is formed as a separate body. In some embodiments, one or both of the first sealing element and the second sealing element are bonded to a portion of the seal case. Any method of bonding a seal to a case are considered to be within the scope of this disclosure. One or more of these sealing elements is composed of a suitable sealing material that can include, by way of examples, a polytetrafluoroethylene (PTFE) material (such as Teflon®, a registered trademark of E.I. Du Pont de Nemours & Company), Gylon®, a registered trademark of Garlock Inc., a fluoropolymer, an elastomeric material, a rubber, a composite, a silicon, and a plastic.

The seal can also include a retaining element, such as a metal or composite washer, that is also carried by the seal case. The retaining element, such as a metal washer, by way of example, can be positioned exterior to the second sealing element. The second sealing element can have any shape including a washer-like that includes an outwardly presented sealing edge dimensioned for defecting and biasing against the sealing surface of the inner race. The first sealing element and the second sealing element are each configured to move in and out along the sealing surface of the inner race for maintaining sealing contact therewith.

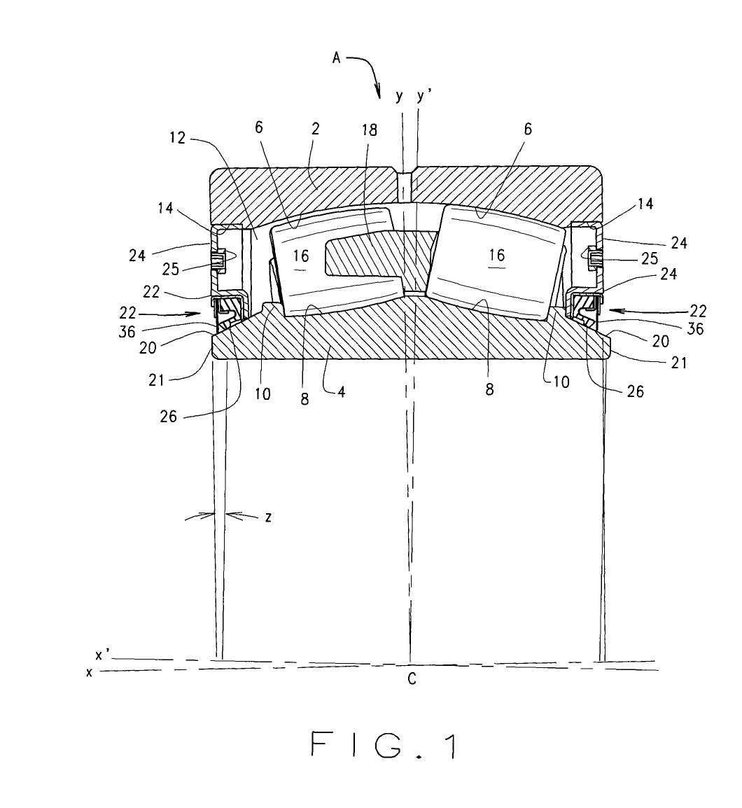

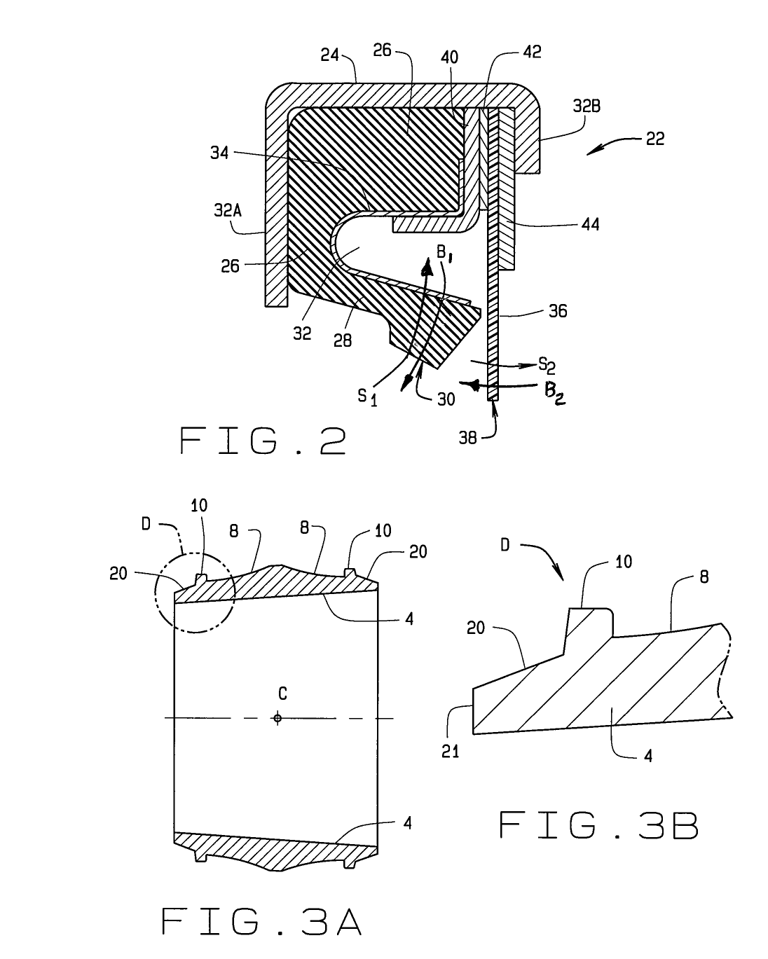

In one particular exemplary embodiment, as illustrated by way of example in FIGS. 1 and 2, a spherical roller bearing assembly A for accommodating rotation about an axis includes an outer race 2 and an inner race 4. The outer race has raceways 6 lying within a spherical envelope having its center at a point C along axis X. The inner race 4 has inner raceways 8 and ribs 10. A bore 12 defined between the inner raceways 8 and the outer raceways 6 and includes end bores 14 at each end of the bore 12. Spherical rollers 16 are positioned in the bore 12 and are held in place with a bearing cage 18. As shown, two sets of rollers 16 are held by the bearing cage 18 and positioned on each side of the axis Y in each of two associated sets of an outer raceway 6 and an inner raceway 8. Both of the races 2 and 4 have longitudinal axes X and X′ respectively, and those axes may coincide (align) or may deviate slightly (misalign).

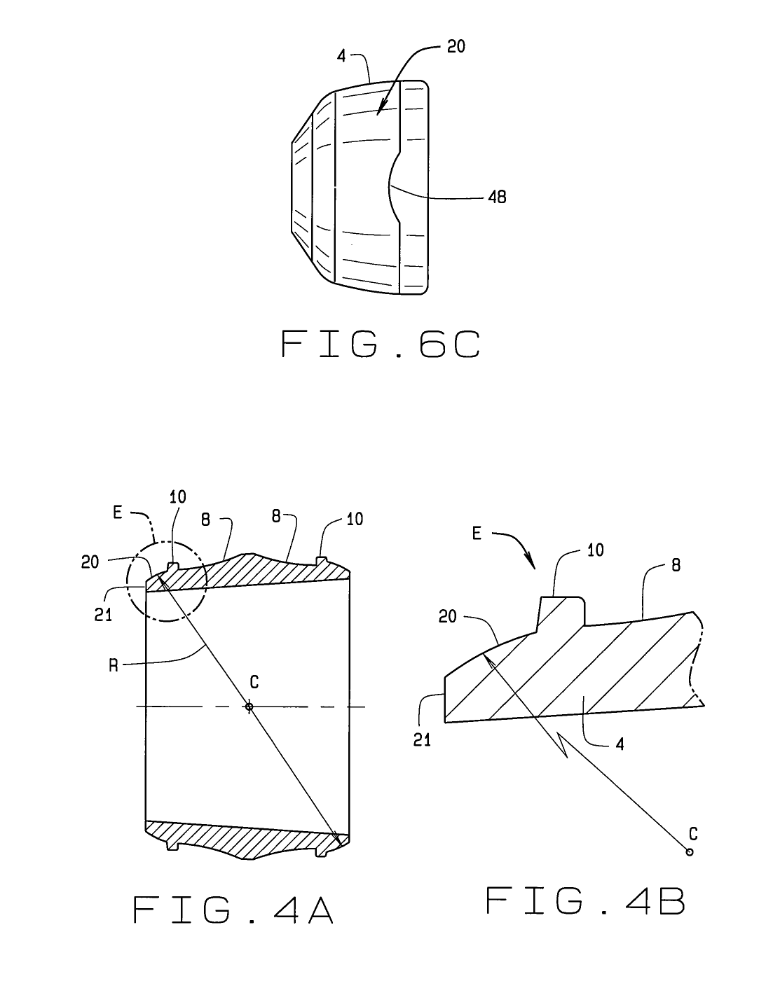

The inner race 4 also includes sealing surfaces 20 that are located between an outer end 21 of the inner race and the ribs 10 and facing inward toward the end bores 14. Each sealing surface 20 can be a sloped linear surface as shown in FIG. 1. These can be tapered such that the sealing surfaces 20 lie within a conical envelope having the axis X or the axis X′ as its center as shown in FIGS. 1, 3A, and 3B. In another embodiment, the sealing surfaces 20 may lie within a spherical envelope having its center essentially at point C as shown in FIGS. 4A and 4B. The inner race 4 also includes outer end 21.

A seal 22, also referred to as a seal assembly, is positioned in each end bore 14 to close the end bore 14. As shown by way of examples in FIGS. 1 and 2, the seal 22 includes a seal case 24, also referred to as a seal holder, which is supported by the outer race 2. In some embodiments, the seal case 24 is dimensioned and configured to be press fit into the end bores 14 and against the outer race 2. The seal 22 closes each end of the end bore 14 and therefore closes the annular spaces of bearing A that are between the surfaces of the outer race 2 and the sealing surfaces 20 on the inner race 4. The seal case 14 can be made of any suitable material and in some embodiments are configured from metal stampings that are configured to be press-fitted into the end bores 14. The seal case 24 can also include one or more inspection ports 25 that maintain a static fluid barrier but that enable an operator to inspect behind the seal case 24. Generally, the seals 22 are supported by the outer race to provide a static fluid barrier with the outer race 2. In some other embodiments, the outer race 2 can also include one or more formations, slots or other means for securing the seal case 24 within the end bores 14, not shown in FIG. 1.

The seal 22 includes a first sealing element 26 that is configured to create and maintain a dynamic fluid barrier to the end bore 14 with the sealing surface 20 of the inner race 4. The first sealing element 26 is held by inwardly turned lips 32, shown as lips 32A and 32B in FIG. 2, of the seal case 24 that form an axially directed socket 27 in which the first sealing element 26 is held. In some embodiments, the first sealing element 26 can be bonded or otherwise secured to the seal case 24. As discussed above, the first sealing element 26 can be an elastomeric material, or other material suitable for forming a sealing contact with the sealing surface 20. As shown in this exemplary embodiment, the first sealing element 26 includes a seal lip 28 having a sealing face 30 that is dimensioned and configured for contacting the sealing surface 20 of the inner race 4. The seal lip 28 is configured to deflect inward as indicated by arrow S₁ and provide a biasing force as indicated by arrow B₁ to form a first sealing contact against sealing surface 20 of the inner race 4. As shown in this example, the first sealing element 26 can include a cavity 32 for forming the seal lip 28. Additionally, in some embodiments a biasing member 34, such as a finger spring, provides for additional biasing of the seal lip 28 against the sealing surface 20 of the inner race 4, for providing additional biasing force B₁.

In addition, the seal 22 of FIG. 2 includes a second sealing element 36 dimensioned and configured for establishing and maintaining a second sealing contact. The second sealing element 36 includes a second sealing face 38 also configured to contact the sealing surface 20 to provide a second dynamic fluid barrier. The second sealing element 36 is configured to deflect in the direction of arrow S₂ during engagement and contact with the sealing surface 20 and provide a biasing force against the sealing surface 20 as indicated by arrow B₂. The second sealing element 36 can be configured from material as described by the above examples.

A metal adapter 40 located between the two lips 32 can provide for securing the first sealing element 26 and also provide for securing a portion of the second sealing element 36. As shown in FIG. 2, a gasket 42 can be positioned external to the metal adapter 40 and against in internal surface of the second sealing element 36. An exterior retainer 44, such as a metal washer, can be positioned external to the second sealing element 36 and under lip 32B for further securing the second sealing element 36. In this embodiment, the second sealing element 36 is thin and generally flat and has a circular edge as the second sealing face 38 along which it contacts the sealing surface 20 for establishing the second dynamic fluid barrier with the sealing surface 20. The second sealing element 36 can resemble a flat washer, and can lie captured between the gasket 42 and the metal washer 44.

As shown, the seal lip 28 of the first sealing element extends obliquely from the inboard end of the seal 10 towards the sealing surface 20 and generally at the inclination of the sealing surface 20. The sealing face 30 is configured to wipe the sealing surface 20 over an area considerably greater than the area contacted by the sealing surface 38, e.g., the edge, of the second sealing element 36.

In operation, the axis of the bearing may vary between an aligned axis X and a misaligned axis X′, the second sealing element 36 remains in contact with the sealing surface 20 and the sealing face 30 remains in contact with the sealing surface 20, thereby providing a dual dynamic fluid barrier with the second sealing surface 20 of inner race 4 during rotation of the outer race 2 about the axis. As such, the two sealing elements 26, 36 each contribute to ensuring that the interior of the bearing A is isolated. Additionally, the dimensions and configurations of the seal 22 allow the bearing to purge some grease beneath the seal lip 28 of the first sealing element 26 into cavity 32 and under the second sealing element to form a barrier to the ingress of contaminants into the bearing assembly A.

The inner race 4 can have several different configurations that can operate with seal 22 for providing the dynamic fluid barriers and to ensure that the first and second sealing elements 26, 36 provide for such. For example, as shown in FIGS. 3A and 3B, the inner race 4 defines the sealing surface 20 as a linear sloped surface from the outer end 21 to the rib 10. In such an embodiment, the sealing surface 20 forms a conical sealing surface on which sealing elements 26 and 36 contact during both aligned and misaligned operation. The sealing faces 30 and 38 contact and ride along the sloped linear sealing surface 20 from the outer end 21 and an outer edge of rib 10 for providing the dual dynamic fluid contacts.

Another exemplary embodiment of the inner race 4 is illustrated in FIGS. 4A and 4B. In this embodiment, the sealing surfaces 20 have a convex curved shape between the outer end 21 and the rib 10. As shown, the curvature of the sealing surface 20 can be spherical and have at the center of the sphere the center point C, which is also the center of the inner race 4. In this embodiment, the sealing elements 26 and 36 and their respective sealing faces 30 and 38 ride the curved sealing surface 20 between the outer end 21 and the rib 10. A curved sealing surface 20, such as the illustrated spherically curved surface of FIG. 4B, can provide for the dual dynamic fluid barrier during both aligned and misaligned operation of the bearing assembly A.

In yet another exemplary embodiment, a spherical roller bearing includes the seal having a first sealing element carried by the seal case that bears against the sealing surface on the inner race and forms a first stage sealing contact. A second sealing element is also carried by the seal case and forms a second stage sealing contact. The first sealing element is configured to establish a first dynamic fluid barrier with the sealing surface of the inner race. A shield is supported by the inner race and defines an inner sealing surface. The second sealing element bears against the inner surface of the shield to establish a face seal contact as the second stage seal contact. The second sealing element is configured to establish a second dynamic fluid barrier with the inner sealing surface of the shield. The shield can be dimensioned to overlap a portion of the seal case supporting the second sealing element for presenting the inner sealing surface to the second sealing element. The first sealing element and the second sealing elements can be formed and/or bonded to the seal case 24 for positioning to form the sealing contacts.

In this embodiment, the first sealing element is configured to move axially along the sealing surface of the inner race for maintaining sealing contact during a misalignment of the inner race to the outer race and the second sealing element is configured to move laterally along the inner sealing surface of the shield for maintaining sealing contact during the misalignment.

Whereas the seal case is supported by the outer race, the shield is supported by the inner race. For example, the inner race can include a mounting cavity or other feature, such as a plurality of slots that are configured for receiving a portion of the shield for supporting the shield thereto.

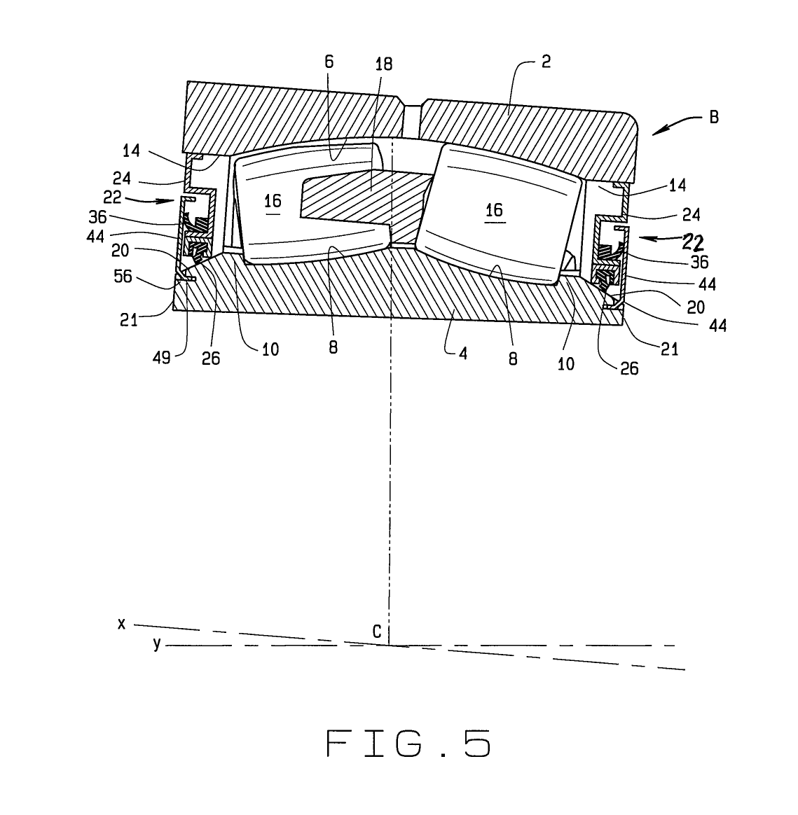

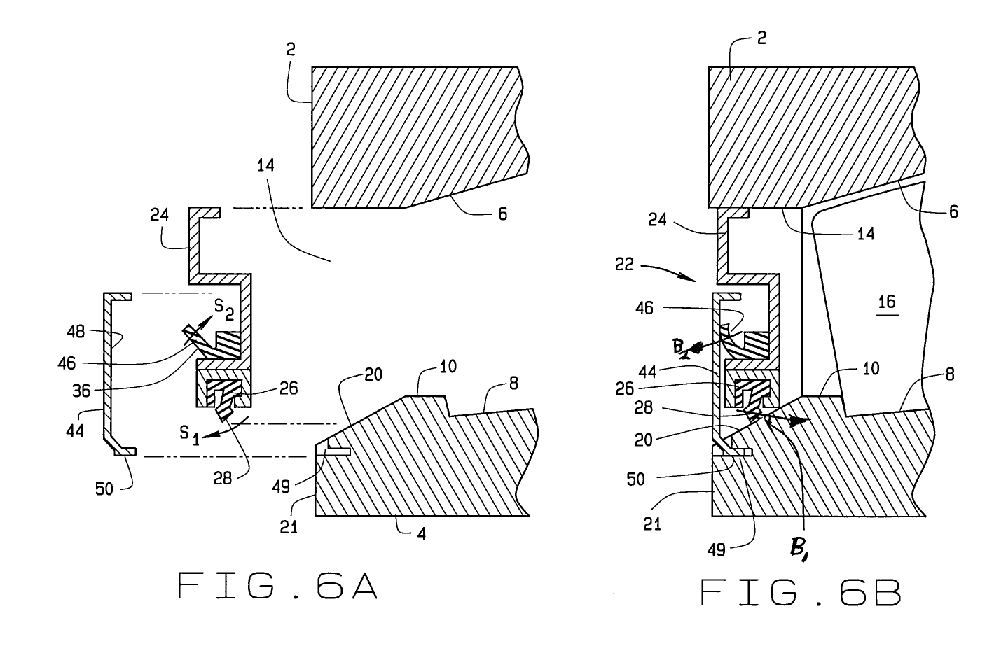

As shown in the exemplary embodiments of FIGS. 5, 6A and 6B, a spherical roller bearing assembly B has an outer race 2, an inner race 4, and spherical rollers 16 arranged in two rows between the outer race 2 and the inner race 4. In addition, the bearing B has a cage 18 for maintaining the proper spacing between the rollers 16 in each of the rows. The seals 22 close the end bores 14 and the access to the annular spaces between the outward race 2 and inner race 4. Both of the races 2 and 4 have longitudinal axes X and X′ respectively, and those axes may coincide (align) or may deviate slightly (misalign). The amount of misalignment is also reflected by angle Z in FIG. 1 and by the variations between axis Y and axis Y′.

In this embodiment, the outer race 2 has a raceway 6 that is presented inwardly toward the axis X and lies within a spherical envelope having a radius r-1 and its center at a point C along the axis X. The outer raceway 6 extends out to end bores 14 that in turn open out of the ends of the outer race 2. The inner race 4 has two inner raceways 8, each having the same radius of curvature as the outer raceway 6. They lead out to ribs 10 which in turn lead out to sealing surfaces 20 at the ends of the race 4. The sealing surfaces 20 lie within a spherical envelope having a radius r-2 and its center essentially at point C as well.

The spherical rollers 16 have curved side faces that establish line contact with the raceways 6 and 8 of outer and inner races 2 and 4, respectively. At those lines of contact, the curvature of the roller side faces match the curvature of the raceways 6 and 8. Those end faces of the rollers 16 that lie beyond the cage 18 bear against and are guided by the ribs 10.

Each seal 22 includes the seal case 24 that is fitted tightly into the end bore 14 at one end of the outer race 6. In addition, each seal 22 has a first sealing element 26 that can be bonded to the seal case 24 near an inner margin. The first sealing element 26 can be molded from an elastomeric material. As shown in this exemplary embodiment, the first sealing element 26 possesses a V-shaped cross-section and at its apex bears against the sealing surface 20 of the inner race 4 to establish a first dynamic fluid barrier. The first sealing element 36 is configured to deflect in the direction of arrow S₁ during contact with sealing surface 20 and provide a biasing force in the direction of arrow B₁ against the sealing surface 20. The seal 22 also has a second sealing element 36 that can also be bonded to the seal case 24 in a radially outward position. The second seal element 36 can also be formed from an elastomeric material.

A shield 44 is supported by the inner race 4 and projects generally radially outwardly away from the inner race 4, yet in close proximity to the seal case 24. The second sealing element 36 can include a second seal lip 46 that deflects in the direction of arrow S₂ during contact with an inner sealing surface 48 of the shield 44 and provide a biasing force in the direction of arrow B₂ against the sealing surface 48 of the shield 44. Generally, the spacing of the shield 44 and the seal case 24 are at least great enough to avoid interference during operation of the bearing assembly B during alignment and maximum misalignment. The second seal lip 46 bears against the inner surface 48 of the shield 44 to form the second dynamic fluid barrier.

Even though the axes X and X′ may vary between aligned and misaligned as also indicated by angle Z in FIG. 1, the first seal lips 28 remains in contact with the sealing surface 20 and the second seal lip 46 remains in contact with the shield 44, thus ensuring that the interior of the bearing is isolated by dual dynamic fluid barriers.

As noted, the shield 44 is supported by the inner race 4. The inner race 4 can include one or more mounting slots 49 configured for receiving and securing a tab 50 or flange of the shield 44 as illustrated in FIGS. 6A, 6B, and 6C. Other forms of securing the shield 44 to the inner race 4 are also suitable.

It should be understood that while the embodiments described herein have identified two sealing elements establishing two sealing contacts and two dynamic fluid barriers, the present disclosure is not limited to two but includes two or more.

As one skilled in the art will understand from the above disclosure, the static and dual dynamic fluid barriers as described herein can provide for sealing a bearing assembly during both align and misalign operation of the bearing. In doing so, the present disclosure can provide for improved operation of the bearing assembly such that grease or other lubricants are retained within the bearing and debris and foreign matter are prevented from entering the bearing assembly. Improved operation and reduced maintenance of bearing assemblies are among the many benefits provided by this disclosure.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1. A bearing assembly for accommodating rotation about an axis, said bearing assembly comprising:
an outer race having an end and a raceway presented inwardly toward the axis;
an inner race having an end and a raceway presented outwardly toward the raceway of the outer race for forming a bore there between, the bore having an outer end and an inner end, the inner race at its end includes a sealing surface that is inclined inwardly away from the raceway and toward the axis;
rollers arranged in a row between the outer and inner raceways;
a shield supported by the inner race and defining an inner sealing surface;
and
a seal positioned in the outer end of the bore, the seal including a seal case supported by the outer race at its end, a first sealing element carried by the seal case, the first sealing element being oriented outwardly from the rollers and bearing directly against the sealing surface on the inner race and forming a first stage sealing contact in a direction towards the outer end of the bore, a second sealing element carried by the seal case and forming a second stage sealing contact, the second sealing element bearing against the inner surface of the shield to establish a face seal contact as the second stage seal contact.

2. The bearing assembly of claim 1 wherein the first sealing element bears against the sealing surface at a distance from the end and the second sealing element bears against the sealing surface proximate to the end.

3. The bearing assembly of claim 1 wherein the seal including a monolithic seal body defining the first sealing element and the second sealing element.

4. The bearing assembly of claim 1 wherein the second sealing element has a body that is independent of a body of the first sealing element.

5. The bearing assembly of claim 1 wherein the first and second sealing elements include at least one of a PTFE and an elastomeric material.

6. The bearing assembly of claim 1 wherein the seal includes a metal washer carried by the seal case and positioned exterior to the second sealing element and wherein the second sealing element has a washer shape that includes an outwardly presented sealing edge configured for deflecting and biasing against the sealing surface of the inner race.

7. The bearing assembly of claim 6 wherein the first sealing element and the second sealing element are each configured to move axially along the sealing surface of the inner race for maintaining sealing contact therewith.

8. The bearing assembly of claim 1 wherein the first sealing element includes a seal lip defining a seal face, the seal lip protruding away from the seal case and biasing the seal face against the sealing surface of the inner race.

9. The bearing assembly of claim 8 wherein the seal includes a biasing element configured for biasing the seal lip of the first sealing element against the sealing surface of the inner race.

10. The bearing assembly of claim 1 wherein the seal case is configured to compressively fit into an end of the bore and against the outer race, and the seal case is configured to establish a static fluid barrier with the outer race and wherein the first and second sealing elements are each configured to establish a dynamic fluid barrier with the inner race.

11. The bearing assembly of claim 1 wherein the inner races race includes a rib presented toward the raceway of the outer race and wherein the sealing surface of the inner race has a convex curved surface presented towards the outer race and extending between an end of the inner race and the rib.

12. (canceled)

13. The bearing assembly of claim 1 wherein the shield is dimensioned to overlap a portion of the seal case supporting the second sealing element for presenting the inner sealing surface to the second sealing element.

14. The bearing assembly of claim 1 wherein the inner race includes a mounting cavity for receiving a portion of the shield for supporting the shield.

15. The bearing assembly of claim 13 wherein the first sealing element includes sealing lip with a protruding V-shaped cross-sectioned distal end.

16. The bearing assembly of claim 1 wherein at least one of the first sealing element and the second sealing element are bonded to a portion of the seal case.

17. The bearing assembly of claim 1 wherein the outer race includes a raceway having a spherical profile, the inner race has a contoured raceway, and the rollers are spherical rollers.

18. A bearing assembly for accommodating rotation about an axis wherein the assembly has an outer race having an end and a raceway presented inwardly toward the axis, an inner race having an end and a raceway presented outwardly toward the raceway of the outer race for forming a bore there between, the bore having an outer end and an inner end, the inner race at its end includes a sealing surface that is inclined inwardly away from the raceway and toward the axis, and rollers arranged in a row between the outer and inner raceways; the bearing assembly further comprising:
a seal positioned in the outer end of the bore, the seal including a seal case supported by the outer race at its end, a first sealing element carried by the seal case, the first sealing element being oriented outwardly from the rollers and bearing directly against the sealing surface on the inner race and forming a first stage sealing contact in a direction towards the outer end of the bore, a second sealing element carried by the seal case and bearing directly against the sealing surface on the inner race external to the first stage sealing contact and forming a second stage sealing contact.

19. A spherical roller bearing assembly for accommodating rotation about an axis, said bearing assembly comprising:
an outer race having ends and raceways with spherical profiles presented inwardly toward the axis;
an inner race having ends and contoured raceways presented outwardly toward the raceways of the outer race and defining a bore there between, the bore having a outer end and an inner end, the inner race at each of its ends having sealing surfaces that are inclined inwardly away from the raceways and toward the axis;
spherical rollers arranged in two rows between the outer and inner raceways, there being a separate row around each inner raceway; and
a seal closing the outer end of the bore, the seal including a seal case supported by the outer race at its end, a first sealing element carried by the seal case, the first sealing element being oriented outwardly from the rollers and bearing directly against the sealing surface on the inner race and forming a first stage sealing contact along an inner portion of the sealing surface in a direction towards the outer end of the bore, and a second sealing element carried by the seal case and bearing directly against the sealing surface of the inner race external to the first stage sealing contact and forming a second stage sealing contact proximate to an end of the sealing surface.

20. The bearing assembly of claim 19 wherein the seal includes a metal washer carried by the seal case and positioned exterior to the second stage sealing element and wherein the second sealing element has a shape of a washer that includes an outwardly presented sealing edge configured for deflecting and biasing against the sealing surface of the inner race.

21. The bearing assembly of claim 19 wherein the first sealing element and the second sealing element are each configured to move axially along the sealing surface of the inner race for maintaining the first and second stage sealing contacts therewith during a misalignment of the inner race to the outer race.

22. The bearing assembly of claim 19 wherein the first sealing element includes a seal lip defining a seal face, the seal lip protruding away from the seal case and biasing the seal face against the sealing surface of the inner race.

23. The bearing assembly of claim 19 wherein the seal includes a biasing element configured for biasing the seal lip towards the sealing surface.

24. The bearing assembly of claim 19 wherein the seal case is configured to compressively fit into the bore and against the outer race to establish a static fluid barrier with the outer race and the first and second sealing elements are configured to establish a dynamic fluid barrier with the sealing surface of the inner race.

25. The bearing assembly of claim 19 wherein the inner races includes ribs presented toward the raceways of the outer race and wherein each sealing surface of the inner race has a convex curved surface presented towards the outer race and extends between an end of the inner race and the associated rib.

26. The bearing assembly of claim 19 wherein at least one of the first sealing element and the second sealing element are bonded to a portion of the seal case.

27. A spherical roller bearing assembly for accommodating rotation about an axis, said bearing assembly comprising:
an outer race having ends and raceways with spherical profiles presented inwardly toward the axis;
an inner race having ends and contoured raceways presented outwardly toward the raceways of the outer race forming a bore there between, the bore having a outer end and an inner end, the inner race at each of its ends having sealing surfaces that are inclined inwardly away from the raceways and toward the axis;
spherical rollers arranged in two rows between the outer and inner raceways, each row being around a different inner raceway;
a seal closing the outer end of the bore, the seal including a seal case supported by the outer race at its end, a first sealing element carried by the seal case, the first sealing element being oriented outwardly from the rollers and bearing directly against the sealing surface on the inner race and forming a first stage sealing contact in a direction towards the outer end of the bore, a second sealing element carried by the seal case and forming a second stage sealing contact; and
a shield supported by the inner race and defining an inner sealing surface, the second sealing element bearing directly against the inner surface of the shield to establish a face seal contact as the second stage seal contact.

28. The bearing assembly of claim 27 wherein the shield is dimensioned to overlap a portion of the seal case supporting the second sealing element for presenting the inner sealing surface to the second sealing element

29. The bearing assembly of claim 28 wherein the inner race includes a mounting cavity for receiving a portion of the shield for supporting the shield.

30. The bearing assembly of claim 27 wherein the first sealing element includes a protruding V-shaped cross-sectioned distal end.

31. The bearing assembly of claim 27 wherein at least one of the first sealing element and the second sealing element are bonded to a portion of the seal case.

32. The bearing assembly of claim 27 wherein the seal case is configured to compressively fit into the bore and against the outer race to establish a static fluid barrier with the outer race, wherein the first sealing element is configured to establish a dynamic fluid barrier with the sealing surface of the inner race and the second sealing element is configured to establish a dynamic fluid barrier with the inner sealing surface of the shield.

33. The bearing assembly of claim 27 wherein the first sealing element is configured to move axially along the sealing surface of the inner race for maintaining the first stage sealing contact during a misalignment of the inner race to the outer race and the second sealing element is configured to move laterally along the inner sealing surface of the shield for maintaining the second stage sealing contact during the misalignment.

34. A bearing assembly for accommodating rotation about an axis wherein the assembly has an outer race having an end and a raceway presented inwardly toward the axis, an inner race having an end and a raceway presented outwardly toward the raceway of the outer race for forming a bore there between, the inner race at its end includes a sealing surface that is inclined inwardly away from the raceway and toward the axis, and rollers arranged in a row between the outer and inner raceways; the bearing assembly further comprising:
means for establishing a static fluid barrier with the outer race;
means for establishing a dynamic fluid barriers with the sealing surface of the inner race; and
means for establishing a second dynamic fluid barrier with at least one of the sealing surface of the inner race and a sealing surface of a shield supported by the inner race.
